(19) United States
(12) Patent Application Publication
(10) Pub. No.: US 2017/0274328 A1
(43) Pub. Date: Sep. 28, 2017

(54) COMPOSITE SEMIPERMEABLE MEMBRANE, SEPARATION MEMBRANE ELEMENT, AND PROCESS FOR PRODUCING SAID MEMBRANE

(71) Applicant: NITTO DENKO CORPORATION, Osaka (JP)

(72) Inventors: Atsuko MIZUIKE, Osaka (JP); Masashi ECHIZEN, Osaka (JP); Kazusa MATSUI, Osaka (JP); Taisuke YAMAGUCHI, Osaka (JP)

(73) Assignee: NITTO DENKO CORPORATION, Osaka (JP)

(21) Appl. No.: 15/508,620

(22) PCT Filed: Aug. 28, 2015
(86) PCT No.: PCT/JP2015/074317

§ 371 Date: Mar. 3, 2017

(30) Foreign Application Priority Data
Sep. 5, 2014 (JP) 2014-181462

(51) Int. Cl. B01D 69/12; B32B 27/12; B32B 27/06

(52) U.S. Cl. CPC B01D 69/125; B32B 27/06; B32B 27/12; B01D 2325/04; B01D 2325/44

(57) ABSTRACT

Provided are a composite semipermeable membrane that will maintain a sufficient level of rejection performance even when produced using different thicknesses of a porous support or different production conditions, a separation membrane element having such a composite semipermeable membrane, and a method for producing such a composite semipermeable membrane. The composite semipermeable membrane includes a porous support including a nonwoven fabric layer and a polymer porous layer on one surface of the nonwoven fabric layer; and a separation function layer on the surface of the porous support, wherein the porous support has a defect frequency F1 of 50 or less per 480 m² with respect to defects having a width of 0.3 mm or more perpendicular to the direction of the polymer porous layer production line, when the relationship between the size and frequency of defects in the porous support is measured with transmitted light.

### TECHNICAL FIELD

The invention relates to a composite semipermeable membrane for separating and/or concentrating specific substances from a variety of liquids. The invention also relates to a separation membrane element having such a composite semipermeable membrane and to a method for producing such a composite semipermeable membrane.

### BACKGROUND ART

In recent years, big coastal cities in arid and semi-arid regions where stable acquisition of water resources is difficult have tried to produce fresh water by desalination of seawater. In addition, areas poor in water resources, such as China and Singapore, have tried to purify and reuse industrial and domestic wastewater. Recently, efforts have also been attempted to remove oils and salts from oil-containing highly-turbid wastewater discharged from oil field plants and other plants so that the resulting water can be reused. For such water treatment processes, membrane methods using composite semipermeable membranes are known to be effective in terms of cost and efficiency.

Such composite semipermeable membranes are known to be produced by forming a separation function layer on the surface of a porous support by interfacial polymerization or other reactions, in which the porous support includes a nonwoven fabric layer and a polymer porous layer on one surface of the nonwoven fabric layer. In this process, the nonwoven fabric used should be less likely to produce defects such as membrane unevenness and pinholes, which would otherwise be caused by fluff or other factors (see Patent Document 1).

### PRIOR ART DOCUMENT

### Patent Document

Patent Document 1: JP-A-2009-61373

### SUMMARY OF THE INVENTION

### Problems to be Solved by the Invention

However, the inventors' study has revealed that such defects in the porous support result not only from the nonwoven fabric but also from other causes such as contamination with air bubbles during the formation of the polymer porous layer. Therefore, the improvement of only the nonwoven fabric has limitations in improving the performance of the composite semipermeable membrane, which will decrease due to defects in the porous support.

So far, it has not yet been sufficiently clarified how defects in the porous support correlates with the rejection performance of the resulting composite semipermeable membrane, and it has been still unclear what level of defect size and frequency is acceptable in terms of rejection performance. It has also been found that an attempt to increase the effective membrane area per unit volume of membrane element by reducing the thickness of the porous support can easily cause an increase in the frequency of defects in the porous support and a decrease in the rejection performance of the composite semipermeable membrane.

It is therefore an object of the invention to provide a composite semipermeable membrane that will maintain a sufficient level of rejection performance even when produced using different thicknesses of the porous support or different production conditions. It is another object of the invention to provide a separation membrane element having such a composite semipermeable membrane and to provide a method for producing such a composite semipermeable membrane.

### Means for Solving the Problems

As a result of intensive studies on the correlation between defects in the porous support and the rejection performance of the resulting composite semipermeable membrane, the inventors have accomplished the invention based on the finding that the problems can be solved by controlling the frequency of defects of certain sizes in the porous support.

Accordingly, the composite semipermeable membrane of the present invention comprises:

a porous support comprising a nonwoven fabric layer and a polymer porous layer on one surface of the nonwoven fabric layer; and

a separation function layer on a surface of the porous support, wherein

the porous support has a defect frequency F1 of 50 or less per 480 m² with respect to defects having a width of 0.3 mm or more perpendicular to a direction of a polymer porous layer production line, when a relationship between size and frequency of defects in the porous support is measured with transmitted light.

For the reasons below, the composite semipermeable membrane of the invention will maintain a sufficient level of rejection performance even when produced using different thicknesses of the porous support or different production conditions.

First, it has been found that as shown in FIG. 1, even when the porous support has a defect with a diameter of about 50 μm (0.05 mm), the separation function layer can have an opening (about 30 μm in diameter). This suggests that even a defect with a size of about 0.05 mm may reduce the rejection performance of the resulting composite semipermeable membrane.

Concerning the target performance, however, the composite semipermeable membrane should have a rejection of around 99.7% against the substance to be separated. Therefore, there is a room to study the correlation between the size and frequency of defects in the porous support and the rejection performance of the resulting composite semipermeable membrane. As shown in the Examples section below, to achieve a rejection of 99.7%, for example, against magnesium sulfate, it is necessary to reduce, to 50 or less per 480 m², the frequency F1 of defects having a width of 0.3 mm or more perpendicular to the direction of the polymer porous layer production line. Studies have also been conducted on the correlation between the frequency of defects of 0.2 mm or more, 0.4 mm or more, or other sizes and the rejection performance of the resulting composite semipermeable membrane. As a result, it has been found that the correlation between them is poor and that there is the highest correlation between the frequency F1 of defects of 0.3 mm or more and the rejection performance. This correlation would adequately apply to cases where the substances to be separated are ionic salts, because the opening of the separation function layer, caused by defects in the porous support, has a size sufficiently larger than the substances to be separated.

By controlling and adjusting the size and frequency of defects in the porous support used, the invention makes it possible to provide a composite semipermeable membrane that will maintain a sufficient level of rejection performance even when produced using different thicknesses of the porous support or different production conditions.

The porous support preferably has a defect frequency F2 of 30 or less per 480 m² with respect to defects having a width of less than 0.3 mm perpendicular to the direction of the polymer porous layer production line, when the relationship between the size and frequency of defects in the porous support is measured with transmitted light. The defect frequency F1 is more preferably 20 or less per 480 m². Satisfying these conditions will more surely increase the rejection performance of the composite semipermeable membrane (for example, a rejection of 99.8% or more against magnesium sulfate).

Even when the polymer porous layer has a thickness of 10 μm to 35 μm, the invention makes it possible to provide a composite semipermeable membrane capable of maintaining a sufficient level of rejection performance. Otherwise, defects can easily occur due to the nonwoven fabric or during the membrane production if the polymer porous layer has a thickness of 10 μm to 35 μm.

The invention is also directed to a separation membrane element including the composite semipermeable membrane having any of the features set forth above. Thus, the separation membrane element of the invention will maintain a sufficient level of rejection performance even when produced using different thicknesses of the porous support or different production conditions, and the thickness of the porous support can be reduced, which makes it possible to increase the effective membrane area per unit volume and to increase the flow rate in the separation membrane element.

On the other hand, the method for producing a composite semipermeable membrane of the present invention comprises the step of:

forming a separation function layer on a surface of a porous support comprising a nonwoven fabric layer and a polymer porous layer on one surface of the nonwoven fabric layer, wherein

the porous support has a defect frequency F1 of 50 or less per 480 m² with respect to defects having a width of 0.3 mm or more perpendicular to a direction of a polymer porous layer production line, when a relationship between size and frequency of defects in the porous support is measured with transmitted light.

Even when using different thicknesses of the porous support or different production conditions, the composite semipermeable membrane-producing method of the invention will successfully produce composite semipermeable membranes having a sufficient level of rejection performance as described above.

The method preferably includes the step of continuously measuring, with transmitted light, the relationship between the size and frequency of defects in a long strip of the porous support while feeding the long strip of the porous support and applying light to the long strip of the porous support. Defects inside the porous support are difficult to detect by the measurement of reflected light, but easy to detect by the measurement of transmitted light, which allows defects to be detected with higher accuracy.

### BRIEF DESCRIPTION OF THE DRAWINGS

FIG. 1 is a scanning electron microscope (SEM) photograph for illustrating the effects of the composite semipermeable membrane of the invention.

FIG. 2 is a partially cutaway perspective view illustrating an example of the structure of a spiral composite semipermeable membrane element usable in the invention.

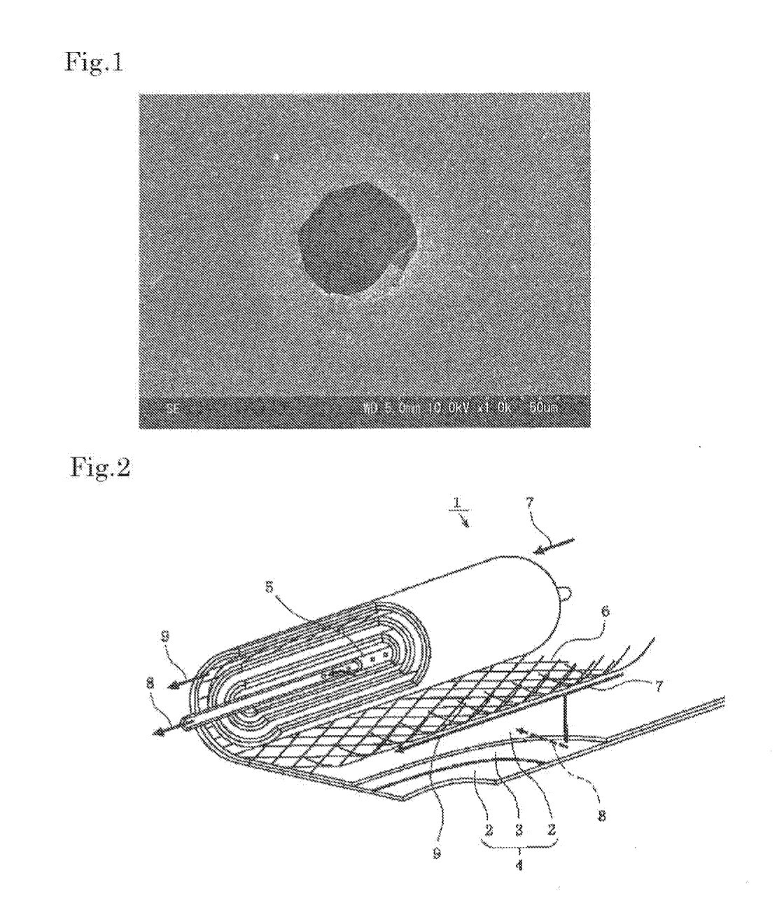

### MODE FOR CARRYING OUT THE INVENTION

The composite semipermeable membrane of the invention includes a porous support including a nonwoven fabric layer and a polymer porous layer on one surface of the nonwoven fabric layer; and a separation function layer on the surface of the porous support. The composite semipermeable membrane may have a thickness of about 40 μm to about 200 μm. If too thin, the composite semipermeable membrane can undergo surface chipping or other damage due to the pressure during treatment, so that a high pressure treatment will be difficult to perform. Therefore, the composite semipermeable membrane preferably has a thickness of 55 μm or more, more preferably 75 μm or more. On the other hand, a larger number of thinner composite semipermeable membranes can be loaded in a given element space to increase the performance. Therefore, the composite semipermeable membrane preferably has a thickness of 120 μm or less, more preferably 90 μm or less.

The composite semipermeable membrane with such features may be called a reverse osmosis (RO) membrane, a nanofiltration (NF) membrane, or a forward osmosis (FO) membrane depending on the filtration performance or the treatment method. The composite semipermeable membrane with such features can be used for ultra-pure water production, seawater desalination, brackish water desalination, wastewater recycling, and other applications.

The separation function layer may be, for example, a polyamide-based, cellulose-based, polyester-based, or silicone-based separation function layer. The separation function layer preferably is a polyamide-based separation function layer. The polyamide-based separation function layer is generally a homogeneous film with no visible pores and has the desired ability to separate ions. The separation function layer may be any polyamide-based thin film resistant to peeling off from the polymer porous layer. For example, there is well-known a polyamide-based separation function layer formed by subjecting a polyfunctional amine component and a polyfunctional acid halide component to interfacial polymerization on a porous support membrane.

Such a polyamide-based separation function layer is known to have a pleated microstructure. The thickness of the polyamide-based separation function layer may be, but not limited to, about 0.05 μm to about 2 μm, preferably 0.1 μm to 1 μm. It is known that if this layer is too thin, membrane surface defects will easily occur, and if it is too thick, permeability will decrease.

Any known method can be used for forming the polyamide separation function layer on the surface of the polymer porous layer without particular limitation. Examples of the method include an interfacial polymerization method, a phase separation method, and a thin film coating method, among which the interfacial polymerization method is especially preferably used in the present invention. The interfacial polymerization method is, for example, a method including coating the polymer porous layer with a polyfunctional amine component-containing aqueous amine solution, and bringing an organic solution containing a polyfunctional acid halide component into contact with the aqueous amine solution-coated surface, so that the interfacial polymerization occurs to form a skin layer. In this method, it is preferable to carry out the procedure by applying the aqueous amine solution and the organic solution to the polymer porous layer and removing the excess portion of these solutions as necessary. In this case, as a method for removing the excess solutions, there are preferably employed a method of flowing the excess solutions by tilting the membrane, a method of blowing a gas to the skin layer to remove the excess solutions, or a method of scraping the excess solutions off by bringing the skin layer into contact with a blade such as a rubber blade.

Further, in the above-mentioned step, the time until the aqueous amine solution comes into contact with the organic solution depends on the composition and viscosity of the aqueous amine solution as well as the size of pores in the surface of the porous support membrane, and the time is about 1 to 120 seconds, preferably about 2 to 40 seconds. When the interval is excessively long, the aqueous amine solution permeates and diffuses deeply inside the porous support membrane, and a large amount of an unreacted polyfunctional amine component may remain in the porous support membrane to cause problems. When the interval between the applications of the solutions is excessively short, too large an amount of an excess aqueous amine solution remains, which tends to deteriorate the membrane performance.

It is preferable that after the aqueous amine solution and the organic solution are brought into contact with each other, a skin layer is formed by heating and drying the solutions at 70° C. or higher. In this way, the mechanical strength and heat resistance of the membrane can be improved. The heating temperature is more preferably 70 to 200° C., particularly preferably 80 to 130° C. The heating time is preferably about 30 seconds to 10 minutes, more preferably about 40 seconds to 7 minutes.

The polyfunctional amine component contained in the aqueous amine solution is defined as a polyfunctional amine having two or more reactive amino groups, and includes aromatic, aliphatic, and alicyclic polyfunctional amines. The aromatic polyfunctional amines include, for example, m-phenylenediamine, p-phenylenediamine, o-phenylenediamine, 1,3,5-triamino benzene, 1,2,4-triamino benzene, 3,5-diaminobenzoic acid, 2,4-diaminotoluene, 2,6-diaminotoluene, N,N′-dimethyl-m-phenylenediamine, 2,4-diaminoanisole, amidol, xylylene diamine etc. The aliphatic polyfunctional amines include, for example, ethylenediamine, propylenediamine, tris(2-aminoethyl)amine, n-phenylethylenediamine, etc. The alicyclic polyfunctional amines include, for example, 1,3-diaminocyclohexane, 1,2-diaminocyclohexane, 1,4-diaminocyclohexane, piperazine, 2,5-dimethylpiperazine, 4-aminomethyl piperazine, etc. These polyfunctional amines may be used independently, and two or more kinds may be used in combination. In particular, in the present invention, it is preferable that the polyfunctional amine component is composed mainly of m-phenylenediamine capable of providing a highly dense separation function layer in the case where a high blocking rate is sought in the reverse osmosis membrane performance. Also, in the case where high flux retention rate is required in the NF membrane performance, it is preferable to use piperazine as a main component.

The polyfunctional acid halide component contained in the organic solution is defined as a polyfunctional acid halide having two or more reactive carbonyl groups, and includes aromatic, aliphatic, and alicyclic polyfunctional acid halides. The aromatic polyfunctional acid halides include, for example trimesic acid trichloride, terephthalic acid dichloride, isophthalic acid dichloride, biphenyl dicarboxylic acid dichloride, naphthalene dicarboxylic acid dichloride, benzenetrisulfonic acid trichloride, benzenedisulfonic acid dichloride, chlorosulfonyl benzenedicarboxylic acid dichloride etc. The aliphatic polyfunctional acid halides include, for example, propanedicarboxylic acid dichloride, butane dicarboxylic acid dichloride, pentanedicarboxylic acid dichloride, propane tricarboxylic acid trichloride, butane tricarboxylic acid trichloride, pentane tricarboxylic acid trichloride, glutaryl halide, adipoyl halide etc. The alicyclic polyfunctional acid halides include, for example, cyclopropane tricarboxylic acid trichloride, cyclobutanetetracarboxylic acid tetrachloride, cyclopentane tricarboxylic acid trichloride, cyclopentanetetracarboxylic acid tetrachloride, cyclohexanetricarboxylic acid trichloride, tetrahydrofurantetracarboxylic acid tetrachloride, cyclopentanedicarboxylic acid dichloride, cyclobutanedicarboxylic acid dichloride, cyclohexanedicarboxylic acid dichloride, tetrahydrofuran dicarboxylic acid dichloride, etc. These polyfunctional acid halides may be used independently, and two or more kinds may be used in combination. In order to obtain a skin layer having higher salt-blocking property, it is preferred to use aromatic polyfunctional acid halides. In addition, it is preferred to form a cross linked structure using polyfunctional acid halides having trivalency or more as at least a part of the polyfunctional acid halide components.

In the interfacial polymerization method, although the concentration of the polyfunctional amine component in the aqueous amine solution is not in particular limited, the concentration is preferably 0.1 to 7% by weight, and more preferably 1 to 5% by weight. When the concentration of the polyfunctional amine component is too low, defects easily occur in the skin layer, and the salt-blocking performance tends to deteriorate. On the other hand, when the concentration of the polyfunctional amine component is too high, the skin layer is too thick, so that the permeation flux tends to decrease.

Although the concentration of the polyfunctional acid halide component in the organic solution is not in particular limited, it is preferably 0.01 to 5% by weight, and more preferably 0.05 to 3% by weight. When the concentration of the polyfunctional acid halide component is too low, an unreacted polyfunctional amine component is increased, and thus defects are likely to occur in the skin layer. On the other hand, if the concentration of the polyfunctional acid halide component is too high, an unreacted polyfunctional acid halide component is increased, and thus the permeation flux tends to decrease because the skin layer is too thick.

The organic solvents for containing the polyfunctional acid halide is not especially limited as long as they have small solubility to water, and do not cause degradation of the porous support, and dissolve the polyfunctional acid halide component. For example, the organic solvents include saturated hydrocarbons, such as cyclohexane, heptane, octane, andnonane, halogenated hydrocarbons, such as 1,1,2-trichlorofluoroethane, etc. They are preferably saturated hydrocarbons having a boiling point of 300° C. or less, and more preferably 200° C. or less.

Additives for the purpose of improving various properties and handling properties may be added to the aqueous amine solution or the organic solution. The additives include, for example, polymers, such as polyvinyl alcohol, polyvinylpyrrolidone, and polyacrylic acids etc.; polyhydric alcohols, such as sorbitol and glycerin; surfactants, such as sodium dodecylbenzenesulfonate, sodium dodecyl sulfate, and sodium lauryl sulfate; basic compounds, such as sodium hydroxide, trisodium phosphate, triethylamine, etc. for removing hydrogen halides formed by polymerization; acylation catalysts; compounds having a solubility parameter of 8 to 14 (cal/cm³)^{1/2} described in Japanese Patent Application Laid-Open No. 08-224452.

The exposed surface of the polyamide separation function layer may be provided with a coating layer made from various polymer components. The polymer component is not particularly limited as long as it is a polymer that does not dissolve the separation function layer and the porous support membrane and does not elute during the water treatment operation. Examples thereof include polyvinyl alcohol, polyvinylpyrrolidone, hydroxypropyl cellulose, polyethylene glycol, and saponified polyethylene-vinyl acetate copolymers. Among these, it is preferable to use polyvinyl alcohol, and particularly preferable to use polyvinyl alcohol having a saponification degree of 99% or more, or to use polyvinyl alcohol having a constitution that it is hardly eluted at the time of water treatment, which is formed by crosslinking polyvinyl alcohol having a saponification degree of 90% or more with the polyamide resin of the skin layer. By providing such a coating layer, the charge state of the membrane surface is adjusted and the hydrophilicity is imparted to the polyamide separation function layer. Therefore, it is possible to suppress the adhesion of contaminants, and to further enhance the flux retention effect by the synergistic effect of the present invention.

The nonwoven fabric layer used in the invention may be of any type capable of maintaining the separation and permeation performance of the composite semipermeable membrane and imparting a suitable level of mechanical strength. A commercially available nonwoven fabric may be used to form the nonwoven fabric layer. The nonwoven fabric layer may be made of, for example, polyolefin, polyester, or cellulose. A mixture of two or more materials may also be used to form the nonwoven fabric. Particularly in view of formability, polyester is preferably used. A long fiber nonwoven fabric or a short fiber nonwoven fabric may also be used as needed. Preferably, a long fiber nonwoven fabric is used in view of fine fluff, which can cause pinhole defects, or membrane surface uniformity. The air permeability of the nonwoven fabric layer alone used in this case may be, but not limited to, about 0.5 to about 10 cm³/cm²·s, preferably about 1 to about 5 cm³/cm²·s.

The thickness of the nonwoven fabric layer is preferably 120 μm or less, more preferably 100 μm or less, even more preferably 78 μm or less. If the thickness is too large, the permeation resistance can be too high so that the flux can easily decrease. Contrarily, if the thickness is too small, the composite semipermeable membrane support can have reduced mechanical strength, which will make it difficult to obtain a stable composite semipermeable membrane. Therefore, the thickness of the nonwoven fabric layer is preferably 30 μm or more, more preferably 45 μm or more.

The polymer porous layer may be of any type capable of forming the polyamide-based separation function layer. In general, the polymer porous layer should be a microporous layer with a pore size of about 0.01 μm to about 0.4 μm. Any of various materials such as polyaryl ether sulfone such as polysulfone and polyether sulfone, polyimide, and polyvinylidene fluoride may be used to form the microporous layer. In particular, polysulfone or polyaryl ether sulfone is preferably used to form the polymer porous layer because of its chemical, mechanical, and thermal stability.

In the invention, the thickness of the polymer porous layer is preferably 35 μm or less, more preferably 32 μm or less. It has been found that if the polymer porous layer is too thick, the flux retention rate can easily decrease after pressurization. The thickness of the polymer porous layer is more preferably 29 μm or less, most preferably 23 μm or less. When the polymer porous layer is made thin to such an extent, the flux retention rate can be made more stable. The thickness of the polymer porous layer is preferably 10 μm or more, more preferably 15 μm or more because if it is too thin, defects can easily occur in it.

There is exemplified a production method when the polymer of the polymer porous layer is a polysulfone. In general, the polymer porous layer can be produced by a method called a wet process or a dry and wet process. It is possible to form a polymer porous layer on the nonwoven cloth through a solution preparation step of firstly dissolving a polysulfone and various additives in a solvent; a coating step of coating the surface of the nonwoven cloth with the solution; a drying step of causing microphase separation by evaporating the solvent in the solution; and a fixing step of immersing the nonwoven cloth in a coagulation bath such as a water bath. The thickness of the polymer porous layer can be set by adjusting the above solution concentration and the coating weight after calculating the ratio of the solution to be impregnated into the nonwoven cloth layer.

In the invention, the porous support obtained as described above has a defect frequency F1 of 50 or less per 480 m², more preferably 20 or less per 480 m², with respect to defects having a width of 0.3 mm or more perpendicular to the direction of the polymer porous layer production line, when the relationship between the size and frequency of defects in the porous support is measured with transmitted light. The porous support preferably has a defect frequency F2 of 30 or less per 480 m² with respect to defects having a width of less than 0.3 mm perpendicular to the direction of the polymer porous layer production line.

Examples of methods for controlling the defect frequency of the porous support in such a way include a method of increasing the smoothness of the nonwoven fabric, a method of increasing the thickness of the polymer porous layer, and a method of preventing the entrainment of air bubbles during the formation of the polymer porous layer.

The method of the invention for producing a composite semipermeable membrane includes the step of forming a separation function layer on the surface of a porous support including a nonwoven fabric layer and a polymer porous layer on one surface of the nonwoven fabric layer, in which the porous support used has a defect frequency F1 at the level specified above. The composite semipermeable membrane can be produced using the method described in detail above.

The production method of the invention preferably further includes the step of continuously measuring, with transmitted light, the relationship between the size and frequency of defects in a long strip of the porous support while feeding the long strip of the porous support and applying light to the long strip of the porous support. This step will be described below.

The long strip of the porous support may be subjected to the measurement immediately after the formation of the polymer porous layer, after storage, or immediately before the formation of the separation function layer. Preferably, the porous support should be subjected to the measurement after the formation of the polymer porous layer, so that only non-defective portions can be used to increase the product yield. In this case, the porous support may be used in a wet state when it is fed before the take-up step on the film production line. The porous support may also be subjected to the measurement using a line specifically designed for the measurement.

For application of light to the porous support, a light source or sources are preferably used in order to increase the amount of light and the accuracy of detection, although environmental light in the line may also be used. When a light source or sources are used, light should be uniformly applied over the entire width to be detected. For this purpose, line light sources arranged linearly are preferably used. The light source for use is preferably a white light source although it may be a specific wavelength light source. Examples of the preferred light source include white LED light sources. Light may be applied to any side of the porous support. Preferably, light is applied to the nonwoven fabric layer side of the porous support while defects are detected on the polymer porous layer side, so that the accuracy of measurement of the defect size can be increased.

The defect detection using transmitted light may be performed with an area camera, a line camera, or other cameras located on the back side opposite to the surface of the porous support to which light is applied. In the invention, only high-speed detection of the defect size should be performed, and therefore, line cameras are preferably used. A variety of line sensor cameras and line scan cameras are commercially available for detection of defects in optical films or other products. Such commercially available cameras may be used in the invention.

While the long strip of the porous support is fed, the line sensor camera can measure the shapes and sizes of individual defects based on how light or dark defects are when light passes therethrough. In the detection, the resolution may be selected depending on the number of pixels in the camera, the scanning period, or other factors. In the invention, the resolution in the widthwise direction perpendicular to the line direction is preferably 0.2 mm or less, more preferably 0.1 mm or less.

In order to increase the accuracy of calculation of the defect frequency, the porous support is preferably measured over a length of 100 m or more, more preferably over a length of 200 m or more, even more preferably over a length of 500 m or more. The detection width is preferably above the product width.

The output signal from the line sensor camera or other cameras may be subjected to data processing for determining the positions and sizes of individual defects, based on which the relationship between the size and frequency of defects is determined.

In the invention, as mentioned above, 0.3 mm is used as a size threshold value for the width perpendicular to the direction of the polymer porous layer production line (the longitudinal direction), and the frequency F1 of defects with a width of 0.3 mm or more is determined. Preferably, the frequency F2 of defects with a width of less than 0.3 mm is also determined.

The resulting porous support with a frequency F1 of 50 or less per 480 m², preferably, with a frequency F1 of 20 or less per 480 m² or preferably with a frequency F2 of 30 or less per 480 m² is used as a high-quality product, which is subjected to the step of forming the separation function layer on the surface of the product.

This makes it possible to produce composite semipermeable membranes with a sufficient level of rejection performance even using different thicknesses of the porous support and different production conditions. The production method described above can successfully produce a composite semipermeable membrane, for example, with a magnesium sulfate rejection of 99.7% or more, preferably with a magnesium sulfate rejection of 99.8% or more.

Generally when used, the composite semipermeable membrane is formed into a separation membrane element and then loaded into a pressure vessel (vessel). Thus, the separation membrane element of the invention has the feature that it contains the composite semipermeable membrane described above.

The separation membrane element may be of any type, such as a flat membrane type such as a frame and plate type, a spiral type, or a pleated type. In general, a spiral composite semipermeable membrane element is preferably used in view of the relationship between pressure and flow efficiency.

As shown in FIG. 2, such a spiral composite semipermeable membrane element for use may include a laminate of a two-folded composite semipermeable membrane 2, a flow path material 6 on the inner surface (concave surface) of the membrane 2, and a flow path material 3 on the outer surface of the membrane 2; a central tube 5 having a plurality of wall holes (perforated hollow tube 5), around which the laminate is wound; and other members, such as an end member and an exterior member, with which the membrane 2 is fixed.

Conventionally, about 20 to 30 sets of envelope-shaped membranes 4 are wound in such a spiral composite membrane element. In contrast, 30 to 40 sets of envelope-shaped membranes 4 can be wound according to the invention. It has been found that this makes it possible to achieve high throughput, so that the treatment efficiency can be significantly improved.

The membrane separation using the spiral composite membrane element 1 is performed as follows. Water 7 is supplied from one end of the element 1. The supplied water 7 is allowed to flow along the supply-side flow path material 6 toward the inner portion, while permeated water 8 produced by separation through the composite semipermeable membrane 2 is introduced along a permeation-side flow path material 3 into the central tube 5 and then discharged from one end of the central tube 5. In this process, the remaining part of the supplied water 7 is discharged as concentrated water 9 from another end of the spiral composite membrane element.

In general, the flow path material has the function of ensuring a space enough to evenly supply the fluid over the membrane surface. The flow path material with such a function may be, for example, a net, a knit fabric, or a corrugated sheet. Any appropriate material with a maximum thickness of about 0.1 mm to about 3 mm may be used as needed. The flow path material is preferably such that it has low pressure loss and can cause a moderate level of turbulent effect. In general, different flow path materials, such as the supply-side flow path material on the supplied liquid side and the permeation-side flow path material on the permeated liquid side, are placed on both surfaces of the separation membrane. The supply-side flow path material should be a thick, large-mesh net-shaped flow path material whereas the permeation-side flow path material should be a small-mesh, woven or knit fabric flow path material.

When an RO membrane or an NF membrane is used for seawater desalination, waste water treatment, or other applications, the supply-side flow path material is placed inside the two-folded composite semipermeable membrane. In general, the supply-side flow path material used preferably has a network structure in which linear parts are arranged to form a lattice. The material used to form the supply-side flow path material may be, but not limited to, polyethylene or polypropylene. These resins may contain a microbicide or an antimicrobial agent. The thickness of the supply-side flow path material is generally from 0.2 mm to 2.0 mm, preferably from 0.5 mm to 1.0 mm. If it is too thick, the amount of the membranes capable of being housed in the element can decrease, as well as the amount of permeation. Contrarily, if it is too thin, deposition of fouling materials can easily occur so that degradation of permeability can easily occur.

In the invention, particularly when the supply-side flow path material with a thickness of 0.9 mm to 1.3 mm is combined with other components, the element can resist the deposition of fouling materials and also resist biofouling, so that the reduction of the flux can be suppressed even during continuous operation.

When an RO membrane or an NF membrane is used for seawater desalination, wastewater treatment, or other applications, the permeation-side flow path material is placed on the outer surface of the two-folded composite semipermeable membrane. The permeation-side flow path material is required to support the membrane from its backside against the pressure applied to the membrane, and also required to establish the flow path for the permeated liquid. In general, the permeation-side flow path material may be a net or a tricot knit fabric made of polyethylene or polypropylene. In particular, a tricot knit fabric made of polyethylene terephthalate is preferably used.

The central tube may be any perforated hollow tube or pipe (hollow tube) whose wall has a plurality of small holes. In general, when the element is used for seawater desalination, wastewater treatment, or the like, the permeated water passing through the composite semipermeable membranes enters the hollow tube from the perforations of the wall to form a permeate flow path. The central tube generally has a length larger than the axial-direction length of the element. Alternatively, a structure of two or more segments joined together may also be used to form the central tube. The material used to form the central tube may be, but not limited to, thermosetting resin or thermoplastic resin.

### EXAMPLES

Hereinafter, the invention will be described in detail with reference to examples and comparative examples, which, however, are not intended to limit the invention. In each example, the physical properties and other properties were evaluated as described below.

(Thickness Measurement)

The thickness measurement was performed using a commercially available thickness gauge (Dial Thickness Gauge G-7C manufactured by OZAKI MFG. CO., LTD.). The thicknesses of the nonwoven fabric layer and the polymer porous layer were measured as follows. The thickness of the nonwoven fabric layer was measured in advance. The polymer porous layer was then formed on the nonwoven fabric layer, and the entire thickness of the resulting composite semipermeable membrane support composed of the unwoven fabric layer and the polymer porous layer was measured. Subsequently, the difference between the thicknesses of the composite semipermeable membrane support and the nonwoven fabric was calculated as the thickness of the polymer porous layer. In each measurement, the thickness was measured at any ten points on the same membrane surface, and the average of the ten measurements was used.

(Measurement of Defects in Porous Support)

While a long porous support was fed and irradiated with light on its nonwoven fabric layer side, the relationship between the size and frequency of defects in the long porous support was continuously measured with transmitted light. Specifically, while the porous support (about 1 m wide) obtained after the formation of the polymer porous layer was fed in a wet state on the line, light was applied from a white LED light source (SPX1150 manufactured by REVOX Inc., about 1 m long) to the nonwoven fabric layer side of the porous support, and the intensity of the light passing through the polymer porous layer was detected by a CCD line sensor camera (CSL8160 manufactured by TOSHIBA TELI CORPORATION, about 1 m in detection length). In the detection, the scan period was so set that a resolution of 0.05 mm was obtained in the line direction, and the measurement was performed with a detection width of 96 cm over a membrane length of about 200 m to about 400 m. The defect frequency was calculated as the number of defects per 480 m² area, which corresponded to a detection length of 500 m.

In this operation, the resolution in the widthwise direction perpendicular to the line direction was 0.075 mm, and individual defects were identified in 0.1 mm widths perpendicular to the line direction. The positions of individual defects were also identified, and then the relationship between the size and frequency of defects was determined.

(Rejection)

The resulting long composite semipermeable membrane was used to form a membrane element (effective membrane area 41 m²) with the same specifications as those of a spiral composite semipermeable membrane element (manufactured by Nitto Denko Corporation, 1,016 mm in length, 8 inches in diameter). The element was loaded into a pressure vessel, and then membrane separation was performed, in which a 2,000 mg/LMgSO₄-containing aqueous solution (solution temperature 25° C.) with an adjusted pH of 6.5 to 7.0 was supplied to the element in the vessel (differential pressure 0.9 MPa, recovery 13%). After this operation was performed for 30 minutes, the conductivity of the resulting permeate water was measured, from which the MgSO₄ rejection (%) was calculated. The MgSO₄ rejection was calculated from the formula below using the correlation (calibration curve) between the MgSO₄ concentration and the conductivity of the aqueous solution, which was obtained in advance.

MgSO₄ rejection (%)={1−(the concentration of MgSO₄ in the permeated liquid)/(the concentration of MgSO₄ in the supplied liquid)}×100

The rejection measurement was performed on two separation membrane elements (N=2).

### Production Example 1 (Porous Supports A to G)

A commercially available polyester nonwoven fabric (about 1 m wide) for a water treatment membrane support was provided which had the physical properties shown in Table 1. On the other hand, a mixed solution of polysulfone and dimethylformamide was prepared with a polymer concentration of 18% by weight. After the polymers were dissolved by heating, the mixed fine air bubbles were removed from the solution under vacuum. While the nonwoven fabric was fed at a fixed speed, the polymer solution was continuously applied to the nonwoven fabric and then subjected to solidification in water at 30° C., so that a long porous support A having an about 25-μm-thick polymer porous layer was obtained.

Long porous supports B to G each having the defect frequency shown in Table 1 were prepared using the same process as described above, except that the type of the nonwoven fabric was changed as shown in Table 1.

### Examples 1 to 3

A solution A containing a mixture of 3.6% by weight of piperazine hexahydrate, 0.15% by weight of sodium lauryl sulfate, 1.5% by weight of sodium hydroxide, and 6% by weight of camphorsulfonic acid was brought into contact with the surface of the polymer porous layer of each of the porous supports A to C, while the porous support was fed, and then the excess solution A was removed, so that a solution A coating layer was formed. Subsequently, a solution B containing 0.4% by weight of trimesic acid chloride in an IP solvent was brought into contact with the surface of the solution A coating layer. The solution A coating layer and the solution B thereon were then subjected to drying in an environment at 120° C. to form a separation function layer, so that a long composite semipermeable membrane was obtained.

### Comparative Examples 1 to 4

Long composite semipermeable membranes were prepared under the same conditions as those in Example 1, except that the porous supports D to G were each used in place of the porous support A.

The resulting composite semipermeable membranes were evaluated as described above. Table 1 shows the evaluation results.

TABLE 1

| | | Example | Example | Example | Comparative | Comparative | Comparative | Comparative |
|---|---|---|---|---|---|---|---|---|
| | | 1 | 2 | 3 | Example 1 | Example 2 | Example 3 | Example 4 |
| Porous support | | A | B | C | D | E | F | G |
| Nonwoven | Thickness (μm) | 58 | 62 | 58 | 63 | 60 | 62 | 59 |
| fabric | Air permeability | 1.8 | 1.3 | 1.45 | 0.85 | 1.35 | 1.65 | 2.3 |
| | (cc/cm3/sec) | | | | | | | |
| | Basis weight (g/m2) | 48.4 | 52 | 49.6 | 58.2 | 50.3 | 54.8 | 50 |
| Defect size | 0 | 0 | 0 | 0 | 0 | 0 | 0 | 0 |
| (mm) | 0.1 | 0 | 9 | 18 | 7 | 21 | 36 | 369 |
| | 0.2 | 3 | 8 | 22 | 23 | 40 | 86 | 655 |
| | 0.3 | 4 | 9 | 18 | 15 | 56 | 54 | 251 |
| | 0.4 | 2 | 2 | 6 | 4 | 9 | 13 | 24 |
| | 0.5 | 1 | 1 | 3 | 9 | 2 | 9 | 37 |
| | 0.6 | 2 | 0 | 4 | 3 | 2 | 4 | 10 |
| | 0.7 | 1 | 2 | 1 | 6 | 6 | 14 | 16 |
| | 0.8 | 0 | 0 | 2 | 1 | 0 | 4 | 6 |
| | 0.9 | 1 | 0 | 0 | 3 | 1 | 0 | 4 |
| | 1.0 or more | 4 | 10 | 8 | 35 | 2 | 5 | 43 |

| | | | | | | | |
|---|---|---|---|---|---|---|---|
| Frequency of defects of less than 0.3 μm | 4 | 17 | 40 | 30 | 61 | 122 | 1024 |
| (per 480 m2) | | | | | | | |
| Frequency of defects of 0.3 μm or more | 14 | 24 | 42 | 66 | 78 | 103 | 391 |
| (per 480 m2) | | | | | | | |
| Rejection (%) | 99.85 | 99.83 | 99.77 | 99.63 | 99.51 | 99.39 | 98.83 |

As shown in Table 1, the magnesium sulfate rejection was 99.7% or more in all of Examples 1 to 3 where the frequency of defects of 0.3 mm or more in the porous support used was 50 or less per 480 m². In particular, the magnesium sulfate rejection was 99.8% or more in Examples 1 and 2 where the frequency of defects of 0.3 mm or more in the porous support used was 20 or less per 480 m² and the frequency of defects of less than 0.3 mm in the porous support used was 30 or less per 480 m².

In contrast, it was found that the magnesium sulfate rejection was in correlation with the defect frequency and lower in Comparative Examples 1 to 4 where the frequency of defects of 0.3 mm or more in the porous support used was more than 50 per 480 m².

### DESCRIPTION OF REFERENCE SIGNS

1 Spiral composite semipermeable membrane element
2 Composite semipermeable membrane
3 Permeation-side flow path material
4 Envelope-shaped membrane
5 Central tube
6 Supply-side flow path material
7 Supplied water
8 Permeated water
9 Concentrated water

1. A composite semipermeable membrane comprising:
a porous support comprising a nonwoven fabric layer and a polymer porous layer on one surface of the nonwoven fabric layer; and
a separation function layer on a surface of the porous support, wherein
the porous support has a defect frequency F1 of 50 or less per 480 m² with respect to defects having a width of 0.3 mm or more perpendicular to a direction of a polymer porous layer production line, when a relationship between size and frequency of defects in the porous support is measured with transmitted light.

2. The composite semipermeable membrane according to claim 1, wherein the porous support has a defect frequency F2 of 30 or less per 480 m² with respect to defects having a width of less than 0.3 mm perpendicular to a direction of a polymer porous layer production line, when a relationship between size and frequency of defects in the porous support is measured with transmitted light.

3. The composite semipermeable membrane according to claim 1, wherein the defect frequency F1 of the porous support is 20 or less per 480 m².

4. The composite semipermeable membrane according to claim 1, wherein the polymer porous layer has a thickness of 10 μm to 35 μm.

5. A separation membrane element comprising the composite semipermeable membrane according to claim 1.

6. A method for producing a composite semipermeable membrane, the method comprising the step of:
forming a separation function layer on a surface of a porous support comprising a nonwoven fabric layer and a polymer porous layer on one surface of the nonwoven fabric layer, wherein
the porous support has a defect frequency F1 of 50 or less per 480 m² with respect to defects having a width of 0.3 mm or more perpendicular to a direction of a polymer porous layer production line, when a relationship between size and frequency of defects in the porous support is measured with transmitted light.

7. The method according to claim 6, further comprising the step of continuously measuring, with transmitted light, a relationship between size and frequency of defects in a long strip of the porous support while feeding the long strip of the porous support and applying light to the long strip of the porous support.
